(19) United States
(12) Patent Application Publication
(10) Pub. No.: US 2025/0075928 A1
(43) Pub. Date: Mar. 6, 2025

(54) IMAGE PROCESSING SYSTEM AND METHOD FOR AIR CONDITIONING SYSTEM

(71) Applicant: Munters Corporation, Amesbury, MA (US)

(72) Inventor: Amit Gitterman, Sandown, NH (US)

(21) Appl. No.: 18/458,342

(22) Filed: Aug. 30, 2023

(51) Int. Cl. F24F 11/52; F24F 11/38; G06T 7/00

(52) U.S. Cl. CPC F24F 11/52; F24F 11/38; G06T 7/0004; G06T 2207/10048; G06T 2207/20081; G06T 2207/20084

(57) ABSTRACT

An image processing system for an air conditioning system, an air conditioning system, and a method of detecting anomalies an air conditioning system. An image processor of the image processing system or air conditioning system is configured to receive an image of at least a portion of a rotor in the air conditioning system. The image processor is also configured to analyze, using an image analysis process executed by the image processor the image to determine an operating condition of the rotor. The image analysis process is configured to detect at least one anomalous operating condition of the rotor, and when the image processor identifies the at least one anomalous operating condition, the image processor is configured to generate an output corresponding to the anomalous operating condition.

### FIELD OF THE INVENTION

The invention relates to air conditioning systems, equipment, and methods, particularly rotary based sorbent conditioning systems, such as desiccant dehumidifiers.

### BACKGROUND OF THE INVENTION

Commercial and industrial scale air conditioning systems are used in a wide variety of applications. Some such air conditioning systems use a sorbent to remove various molecules from an airstream to condition the airstream. The sorbents may be arranged in a rotor to rotate between various zones, such as a process zone where the sorbent removes molecules from process air flowing through the sorbent in the process zone and a regeneration zone where a regeneration airstream removes the molecules from the sorbent to regenerate the sorbent. One example is dehumidification, where the sorbent is a desiccant and the desiccant is used to remove water, such as water vapor, from the process air.

### SUMMARY OF THE INVENTION

In one aspect, the invention relates to methods and systems for monitoring and/or controlling the operation of fluid (air) conditioning systems. Such methods and systems may include capturing images (e.g., still images or video images) of at least a portion of the air conditioning system and analyzing the images to determine an operating condition of the air conditioning system. To make such a determination, an image processor may execute an image analysis process using, for example, an artificial neural network trained to identify the operating condition.

In another aspect, the invention relates to an air conditioning system for conditioning process air. The air conditioning system includes a rotor, an image sensor, and an image processor. The rotor contains a sorbent arranged in the rotor to allow the process air to flow therethrough. The image sensor is positioned to capture an image of at least a portion of the rotor. The image processor is configured to receive the image captured by the image sensor and to analyze, using an image analysis process executed by the image processor, the image to determine an operating condition of the rotor. The image analysis process is configured to detect at least one anomalous operating condition of the rotor, and when the image processor identifies the at least one anomalous operating condition, the image processor is configured to generate an output corresponding to the anomalous operating condition.

In a further aspect, the invention relates to an image processing system for an air conditioning system. The image processing system includes an image processor. The image processor is configured to receive an image of at least a portion of a rotor in the air conditioning system. The rotor includes sorbent arranged in the rotor to allow air to flow therethrough. The image processor is also configured to analyze, using an image analysis process executed by the image processor the image to determine an operating condition of the rotor. The image analysis process is configured to detect at least one anomalous operating condition of the rotor, and when the image processor identifies the at least one anomalous operating condition, the image processor is configured to generate an output corresponding to the anomalous operating condition.

In yet another aspect, the invention relates to a method of detecting anomalies in a rotary sorbent air conditioning system. The method includes receiving an image of at least a portion of a rotor containing a sorbent. The sorbent is arranged in the rotor to allow air to flow therethrough. The method also includes analyzing, using an image analysis process executed by an image processor, the image to determine an operating condition of the rotor. The image analysis process is configured to detect at least one anomalous operating condition of the rotor, and when the image processor identifies the at least one anomalous operating condition, the method includes generating an output corresponding to the anomalous operating condition.

In still another aspect, the invention relates to a non-transitory computer-readable storage medium having stored thereon a sequence of instructions that, when executed by a processor, cause the processor to perform an image analysis process to determine an operating condition of a rotor of a rotary sorbent air conditioning system. The image analysis process executed by the processor includes executing a neural network model that has been trained using a training database comprising a plurality of training images of at least a portion of a face of the rotor. The rotor contains a sorbent.

These and other aspects of the invention will become apparent from the following disclosure.

### BRIEF DESCRIPTION OF THE DRAWINGS

FIG. 1 is a schematic view of a dehumidification system including a desiccant rotor that includes a rotor monitoring system according to a preferred embodiment.

FIG. 2 is a schematic view of another dehumidification system including a desiccant rotor that includes the rotor monitoring system.

FIG. 3 is a schematic view of the rotor monitoring system with an image processor as a part of a controller of the dehumidification system.

FIG. 4 is a schematic view of the rotor monitoring system with the image processor separate from the controller of the dehumidification system.

FIG. 5 is a flow chart of a process used by the rotor monitoring system to determine an operating condition of the desiccant rotor.

FIG. 6 is a grayscale representation of an image captured by an image sensor of the rotor monitoring system.

FIGS. 7A-7D are grayscale representations of images captured by an image sensor of the rotor monitoring system. FIGS. 7A-7D show a plurality of successive captured images, with FIG. 7A being an image captured at a first time, FIG. 7B being an image captured at a second time, FIG. 7C being an image captured at a third time, and FIG. 7D being an image captured at a fourth time.

### DETAILED DESCRIPTION OF THE PREFERRED EMBODIMENTS

As used herein, the terms “upstream” and “downstream” are taken with respect to the flow of a fluid in a fluid pathway, such as, for example, the flow of process air in the dehumidification system.

As discussed above, air conditioning systems may include a rotor-based sorbent, such as a desiccant, that moves through a plurality of zones. Seals may be formed with the face of the rotor to separate adjacent zones or formed around the periphery of the rotor. In addition, the rotor may be supported by various components such as a shaft and/or rollers. During the lifetime of the rotor, these components (e.g., seals, shaft, and rollers) may degrade because of aging or other wear and tear, and thus, over time, the performance of the sorbent/rotor may degrade. The air conditioning systems and methods discussed herein utilize images of a face of the rotor to identify the conditions of the rotor, so as to identify various nonuniformities and abnormalities on the face of the rotor. The conditions of the rotor may be used for system diagnostics and, more specifically, real time system diagnostics. The system diagnostics may be used to adjust the operation of the air conditioning system or identify the need for maintenance or repair.

Existing control methodologies for rotor-based sorbent air conditioning systems may use single point sensors, such as a temperature sensor, located in an airstream. These temperature sensors may be located at one or two positions in the airstream, such as the outlet of a reactivation airstream and/or the inlet of the reactivation airstream, with control being based on the temperatures sensed at these locations. Reactivation control methodologies using this method involve a simplification (or misconception) of a uniform temperature profile across the rotor longitude. Conditions can occur, however, where the moisture and temperature are not uniform over the reactivation segment of the rotor; for example, the rotor core may be saturated after a rotation of the rotor through the process side, with the rotor periphery being relatively dry. The monitoring system (system diagnostics) discussed herein may be used to adjust the operation of the air conditioning system to more accurately control the air conditioning system, such as more accurately identify how much and where to target reactivation air.

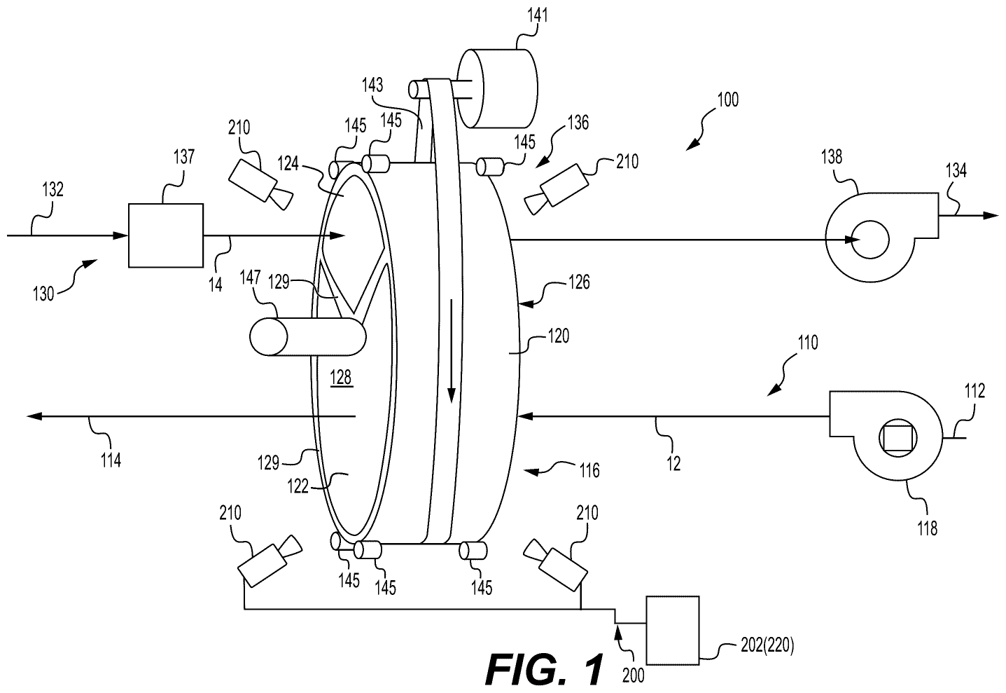

One suitable application for the monitoring system discussed herein is a rotary based dehumidification system. FIG. 1 is a schematic of a dehumidification system 100 that may include a rotor monitoring system 200 according to a preferred embodiment. The dehumidification system may be used to condition air and, more specifically, dehumidify air. The air being dehumidified (conditioned) is referred to herein as process air 12, and the dehumidification system includes a process airflow. The dehumidification system then provides the conditioned (dehumidified) air, as supply air, to a space, such as a room. The air being conditioned (process air 12) may be drawn from various suitable sources including ambient air outside of the room or recirculated air (return air) from within the room. The dehumidification system 100 includes a process air plenum 110. The process air 12 enters the process air plenum 110 via a process air inlet 112, flows through the process air plenum 110 where it is dehumidified, and then flows out of the process air plenum 110 via a process air outlet 114.

The dehumidification system 100 includes a desiccant rotor 120 containing a desiccant located therein. Suitable desiccants include, for example, titanium silicagel and lithium chloride. Such desiccants may be arranged in a porous structure through which air can flow. As shown in FIG. 1, the desiccant rotor 120 is a rotating Honeycombe® wheel, such as the desiccant wheel produced by Munters Corp. of Amesbury, Massachusetts, USA. In the desiccant wheel, the desiccant may be formed, for example, by being impregnated into a semi-ceramic honeycomb structure or other porous structure. The desiccant rotor 120, however, is not limited to such honeycomb structures, but includes other rotary desiccant systems where the desiccant may have other arrangements. For example, the desiccant may also be formed as granules or particulates and form a porous mass through which air can flow. Such granular desiccant may be formed in beds that are arranged horizontally or in multiple vertical beds.

A portion of the desiccant rotor 120 is located in the process air plenum 110 and positioned to allow the process air 12 to flow through the desiccant in the desiccant rotor 120 located within the process air plenum 110. The portion of the process air plenum 110 in which the desiccant is located is a sorption section 116 of the dehumidification system 100, and the portion of the desiccant rotor 120 through which the process air 12 flows is referred to as the process segment 122 (or process zone) of the desiccant rotor 120. The process air 12 flows through the process segment 122 and moisture from the process air 12 is absorbed by the desiccant in the process segment 122, dehumidifying the process air 12. In the process segment 122 (the sorption section 116), the surface vapor pressure of the desiccant is lower than the process air 12 allowing the desiccant to absorb moisture from the process air 12.

As the desiccant absorbs moisture from the process air 12, the ability for the desiccant to absorb additional moisture is reduced, as the surface vapor pressure of the desiccant increases because of absorption. The desiccant is thus reactivated (regenerated) to restore its ability to absorb moisture. In this embodiment, the desiccant is reactivated using reactivation air 14 and the dehumidification system includes a reactivation airflow. The reactivation air 14 may be drawn from various suitable sources including ambient air. The dehumidification system 100 includes a reactivation air plenum 130. The reactivation air 14 enters the reactivation air plenum 130 via a reactivation air inlet 132, flows through the reactivation air plenum 130 where the reactivation air 14 is used to reactivate the desiccant, and then flows out of the reactivation air plenum 130 via a reactivation air outlet 134. The portion of the desiccant rotor 120 through which the reactivation air 14 flows is referred to as the reactivation segment 124 (or reactivation zone) of the desiccant rotor 120. The reactivation air 14 flows through the reactivation segment 124 and removes moisture from the desiccant in the reactivation segment 124, reactivating (regenerating) the desiccant. The portion of the reactivation air plenum 130 in which the desiccant is located is a desorption section 136 of the dehumidification system 100. Within the reactivation segment 124 (the desorption section 136), the desiccant has a surface vapor pressure that is significantly higher than the reactivation air 14 so moisture from the desiccant is transferred to the reactivation air 14 to equalize the pressure differential.

In this embodiment, the desiccant rotor 120 is rotatable to move the desiccant between the sorption section 116 and the desorption section 136. Various suitable mechanisms may be used to rotate the desiccant rotor 120. As shown in FIG. 1, for example, a motor 141 is drivingly coupled to the desiccant rotor 120 to transmit torque to the desiccant rotor 120 and rotate the desiccant rotor 120. The motor 141 may be coupled to the desiccant rotor 120 by various suitable means including, for example, by a belt 143. The motor 141 rotates the belt 143, which in turn rotates the desiccant rotor 120. The desiccant is fixed within the desiccant rotor 120 and rotates with the rotation of the desiccant rotor 120. The desiccant is thus a moveable desiccant that moves between the sorption section 116 and a desorption section 136 of the dehumidification system 100. In embodiments using the desiccant rotor 120, the desiccant is exposed to a continuous repeating cycle of sorption and desorption to continuously dry the process air 12.

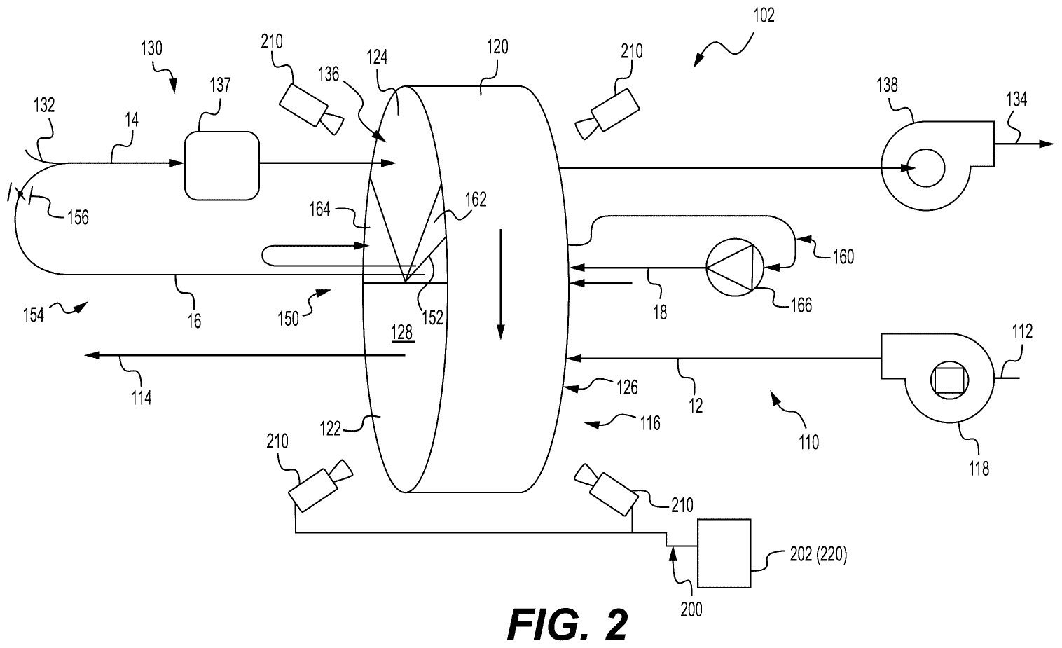

The desiccant rotor 120 may be rotatably supported by various suitable means. As shown in FIG. 1, for example, the desiccant rotor 120 may be supported by a plurality of rollers 145 abutting the outer circumferential surface of the desiccant rotor 120. Additionally or alternatively, the desiccant rotor 120 may include a shaft 147 (e.g., a central shaft) supported by bearings. In some embodiments, the motor 141 may rotate the shaft 147 to rotate the desiccant rotor 120. (Note, these features are omitted from FIG. 2, discussed below, for clarity.)

The surface vapor pressure of the desiccant in the reactivation segment 124 (desorption section 136) should be higher than the vapor pressure of the reactivation air 14 to reactivate the desiccant. To increase the surface vapor pressure of the desiccant, the desiccant may be heated such as by using hot reactivation air 14. Accordingly, in some embodiments, the reactivation air 14 may be heated. Optionally, the dehumidification system 100 may include a heater 137 located within the reactivation airflow, such as within the reactivation air plenum 130, upstream of the desiccant rotor 120 and, more specifically, upstream of the desorption section 136. Suitable heaters include, for example, a direct electrical heater (e.g., resistive heater), a gas-fired heater, and/or a heat-pump module.

The dehumidification system 100 also includes a process blower 118. The process blower 118 is configured to produce a process airflow of the process air 12 within the dehumidification system 100. In this embodiment, the process blower 118 is positioned upstream of the desiccant rotor 120 and, more specifically, upstream of the sorption section 116. Similarly, the dehumidification system 100 may include a reactivation blower 138 to generate the reactivation airflow. The reactivation blower 138 may be positioned downstream of the desiccant rotor 120 and, more specifically, downstream of the desorption section 136.

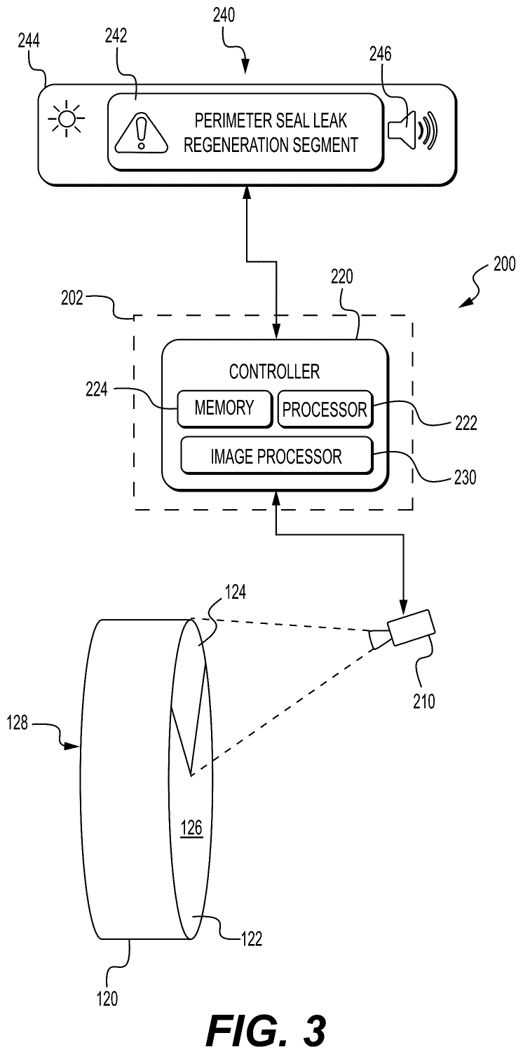

The desiccant rotor 120 includes a first face 126 (see also FIG. 3) and a second face 128. In the process segment 122, the first face 126 is an upstream face relative to the flow of the process air 12 and the second face 128 is a downstream face relative to the flow of the process air 12. In this embodiment, the process air 12 and the hot reactivation air 14 are arranged in a counter flow arrangement, and thus, in the reactivation segment 124, the first face 126 is a downstream face relative to the flow of the hot reactivation air 14 and the second face 128 is an upstream face relative to the flow of the hot reactivation air 14. The process segment 122 is separated from the reactivation segment 124 by at least one seal assembly 129. Each seal assembly 129 includes a seal, and seals include for example, face seals, such as elastomeric face seals. In this embodiment, the seals of the seal assemblies 129 are positioned to contact each of the first face 126 and the second face 128. Such face seals may have various suitable shapes including an O-shaped seals, D-shaped seals, and ∩-shaped seals. A seal as part of a seal assembly 129 may also be formed around the periphery of the desiccant rotor 120. In FIG. 1 the seal assemblies 129 are shown on the second face 128, but they may also be positioned in a similar arrangement on the first face 126. (Note, the seal assemblies 129 are omitted from FIG. 2, discussed below, for clarity).

FIG. 2 is a schematic of another dehumidification system 102 that includes a rotor monitoring system 200. As noted above, the desiccant rotor 120 may have a plurality of segments (or zones). The dehumidification system 100 shown in FIG. 1 includes two segments (or zones)—a process segment 122 (or process zone) and a reactivation segment 124 (or reactivation zone)—but more than two segments may be used. The dehumidification system 102 shown in FIG. 2 includes a desiccant rotor 120 with more than two segments. The dehumidification system 102 in FIG. 2 is similar to the dehumidification system 100 in FIG. 1, and the same reference numerals will be used for components of the dehumidification system 102 shown in FIG. 2 that are the same or similar to the dehumidification system 100 discussed above. The discussion of these components above also applies to the dehumidification system 102 shown in FIG. 2 and a detailed discussion of these components is omitted here.

The dehumidification system 102 shown in FIG. 2 includes a bypass regeneration system 150. The desiccant rotor 120 includes a bypass segment 152 (or bypass zone). A portion of the process air 12 (referred to herein as bypass air 16) flows through the bypass segment 152 and moisture from the bypass air 16 is absorbed by the desiccant in the bypass segment 152 in a manner similar to the process segment 122 discussed above. The bypass air 16 may be used as at least a portion of the reactivation air 14. Thus, instead of being directed to the process air outlet 114, the bypass air 16 flows through a bypass plenum 154 fluidly connecting the process air plenum 110 with the reactivation air plenum 130. A bypass damper 156 may be used to control the flow of bypass air 16 used as the reactivation air 14.

The dehumidification system 102 shown in FIG. 2 also includes a purge system 160, and the desiccant rotor 120 of this embodiment also includes a first isolation segment 162 (first isolation zone) and a second isolation segment 164 (second isolation zone). Isolation air 18 is circulated in a closed loop, independent of the process air 12, the reactivation air 14, and the bypass air 16, between the desiccant in the first isolation segment 162 and in the second isolation segment 164. The isolation air 18 is circulated by an isolation blower 166. As discussed above, the reactivation air 14 heats the desiccant in the reactivation segment 124. The first isolation segment 162 is positioned downstream of the reactivation segment 124 in the direction of rotation of the desiccant rotor 120, and, in this embodiment, adjacent to each of the reactivation segment 124 and the bypass segment 152. As the isolation air 18 passes through the desiccant in the first isolation segment 162, the isolation air 18 absorbs heat from the desiccant, cooling the desiccant before it enters the process segment 122 and heating the isolation air 18. The now heated isolation air 18 is then circulated through the second isolation segment 164 to preheat the desiccant in the second isolation segment 164. The second isolation segment 164 is positioned upstream of the reactivation segment 124 in the direction of rotation of the desiccant rotor 120, and, in this embodiment, adjacent to each of the reactivation segment 124 and the process segment 122.

The dehumidification systems discussed herein (dehumidification system 100 or dehumidification system 102, for example) include a rotor monitoring system 200. FIG. 3 is a schematic view of the rotor monitoring system 200. The following discussion will reference the dehumidification system 100 shown in FIG. 1, but is equally applicable to the dehumidification system 102 shown in FIG. 2. The rotor monitoring system 200 may be used to provide alerts and or other notifications. In other embodiments, the rotor monitoring system 200 may be used to implement or trigger other actions on the dehumidification system 100. The rotor monitoring system 200 is communicatively coupled to a control system 202 for the dehumidification system 100, and in this embodiment, the rotor monitoring system 200 is implemented within the control system 202 of the dehumidification system 100.

The rotor monitoring system 200 of the embodiments discussed herein utilizes at least one image sensor 210. Suitable image sensors 210 may include visual image sensors and thermal image sensors. Visual image sensors may be, for example, cameras with sensors that sense visual light to create still images or video images. Likewise, thermal image sensors may be, for example, cameras with sensors that are used to generate a thermal image, whether still or visual, indicating temperature. Sensors used in thermal image sensors include infrared image sensors, such as longwave infrared sensors or midwave infrared sensors, or near-infrared image sensors. The image sensor 210 may be a hyperspectral sensor or a multispectral sensor. In preferred embodiments, the image sensor 210 may be a longwave infrared camera. Temperature and moisture content may be related in the dehumidification system 100 discussed herein and thus moisture content may be determined based on the temperature detected using the thermal image sensors discussed herein. In other embodiments, the sensors may be water vapor sensors or sensors that detect or image other molecules within the air.

The image sensor 210 has a field of view, which is the area captured, or imaged, by the image sensor 210. The image sensor 210 is positioned within the dehumidification system 100 to have a field of view of at least a portion of the desiccant rotor 120 and, more specifically, at least a portion of one of the first face 126 or the second face 128. In some embodiments, a plurality of image sensors 210 may be used. When a plurality of image sensors 210 are used, multiple image sensors of the same type (e.g., multiple video cameras) may be used and/or image sensors of a different type (e.g., both a video camera and an infrared image sensor) may be used. As shown in FIGS. 1 and 2, for example, at least one image sensor 210 is positioned to image a portion of one of the first face 126 or second face 128 in each segment. A plurality of image sensors 210 may be used in each segment to image a portion of one of the first face 126 or second face 128 in each segment. When a plurality of image sensors 210 are used in each segment, the images from adjacent image sensors 210 may be stitched together to form a composite image. When the image sensor 210 or a plurality of image sensors 210 are used to image only a portion of one of the first face 126 or second face 128 in a segment, such image sensors 210 may be strategically placed to image sensitive areas, such as the peripheries of the segment, like areas adjacent to a seal of one of the seal assemblies 129 and, more specifically, the seal of the seal assembly 129 on the upstream side of the segment relative to the rotation direction of the desiccant rotor 120.

As shown in FIG. 3, the control system 202 includes a controller 220. In this embodiment, the controller 220 may be a computing device having one or more processors 222 and one or more memories 224. The processor 222 can be any suitable processing device, including, but not limited to, a microprocessor, a microcontroller, an integrated circuit, a logic device, a programmable logic controller (PLC), an application-specific integrated circuit (ASIC), and/or a Field Programmable Gate Array (FPGA). The memory 224 can include one or more computer-readable media, including, but not limited to, non-transitory computer-readable media (non-transitory computer-readable storage media), a computer-readable non-volatile medium (e.g., a flash memory), a RAM, a ROM, hard drives, flash drives, and/or other memory devices.

The memory 224 can store information accessible by the processor 222, including computer-readable instructions that can be executed by the processor 222. The instructions can be any set of instructions or a sequence of instructions that, when executed by the processor 222, causes the processor 222 and the controller 220 to perform operations. In some embodiments, the instructions can be executed by the processor 222 to cause the processor 222 to complete any of the operations and functions for which the controller 220 is configured, as will be described further below. The instructions can be software written in any suitable programming language, or can be implemented in hardware. Additionally, and/or alternatively, the instructions can be executed in logically and/or virtually separate threads on the processor 222. The memory 224 can further store data that can be accessed by the processor 222.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between components and among components. For instance, processes discussed herein can be implemented using a single computing device or multiple computing devices working in combination. Databases, memories, instructions, and applications can be implemented on a single system or distributed across multiple systems. Distributed components can operate sequentially or in parallel.

In this embodiment, the controller 220 is a microprocessor-based controller that includes the processor 222 for performing various functions discussed further below, and the memory 224 for storing various data. The various methods discussed below may be implemented by way of a series of instructions stored in the memory 224 and executed by the processor 222. The rotor monitoring system 200 also includes an image processor 230. In the embodiment shown in FIG. 3, the image processor 230 is incorporated into the controller 220 either as a separate processor or as the processor 222, and in this way the image processor 230 is communicatively coupled to the controller 220 as part of the internal connections of the controller 220.

The image sensors 210 are communicatively coupled to the image processor 230 and, in this embodiment, are communicatively coupled to the controller 220. The image sensors 210 may be communicatively coupled to the controller 220 using any suitable means. In this embodiment, the image sensors 210 are coupled to the controller 220 with a wired connection, but other suitable connections may be used, such as wireless connections. Suitable connections include, for example, an electrical conductor, a low-level serial data connection, such as Recommended Standard (RS) 232 or RS-485, a high-level serial data connection, such as Universal Serial Bus (USB) or the Institute of Electrical and Electronics Engineers (IEEE) 1394, a parallel data connection, such as IEEE 1284 or IEEE 488, and/or a short-range wireless communication channel, such as BLUETOOTH, and/or wireless communication networks using radio frequency signals, such as Wi-Fi. When a wired connection and protocol is used, each of the image sensors 210 and the controller 220 may include a suitable port to support the wired connection. When a wireless protocol is used, each of the image sensors 210 and the controller 220 may include a transmitter and/or a receiver.

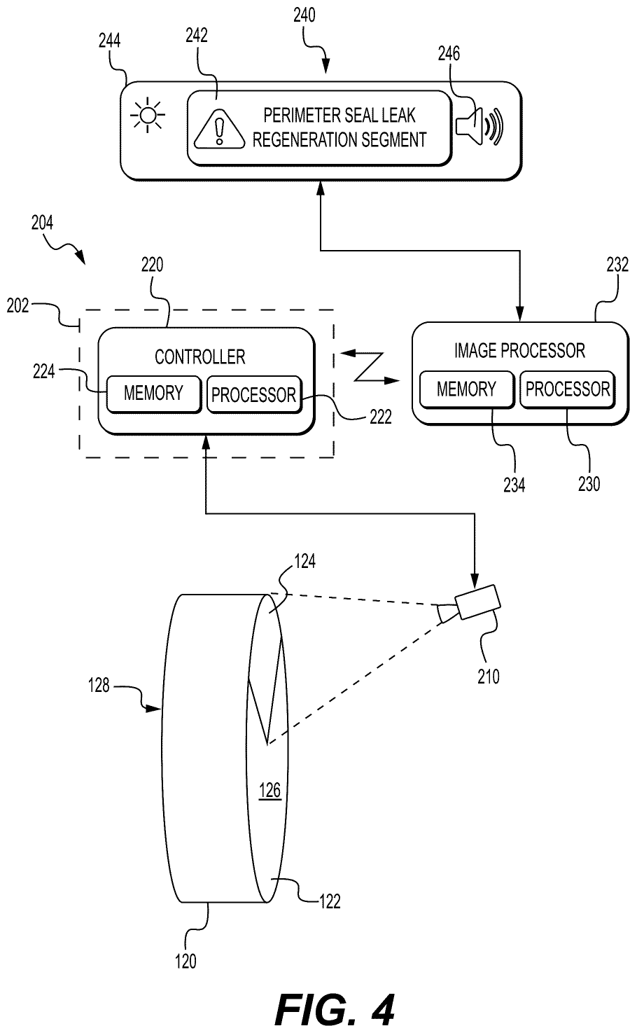

In other embodiments, the image processor 230 may be a processor that is part of a computing device (with its own memory) separate from the controller 220; such an embodiment is shown in FIG. 4, for example. When the image processor 230 is separate from the controller 220, the image processor 230 may be part of a computing device 232 with its own memory 234. Such a computing device 232 may be a general-purpose computer or other computing device similar to the controller 220 discussed above, and the discussion of the configuration of the controller 220 also applies to the computing device 232. In this embodiment, the image processor 230 is communicatively coupled to the controller 220. The computing device 232 and the image processor 230 may be coupled to the controller 220 by a network or any one of the connections discussed above relative to the connection between the image sensors 210 and the controller 220. When a network is used, the network may be a local area network (LAN), a wide area network (WAN), a public network, a private network, a proprietary network, a Public Switched Telephone Network (PSTN), the Internet, a wireless network, a virtual network, or any combination thereof. The network may also include various network access points, e.g., wired or wireless access points such as base stations or Internet exchange points, through which a data source may connect to the network in order to transmit information via the network. FIG. 4 is a schematic of a rotor monitoring system 204, with the image processor 230 separate from the control system 202 of the dehumidification system 100. The rotor monitoring system 204 shown in FIG. 4 is otherwise the same as the rotor monitoring system 200 shown in FIG. 3. The following description will reference the rotor monitoring system 200 shown in FIG. 3, but the description applies to the rotor monitoring system 204 shown in FIG. 4, unless otherwise indicated.

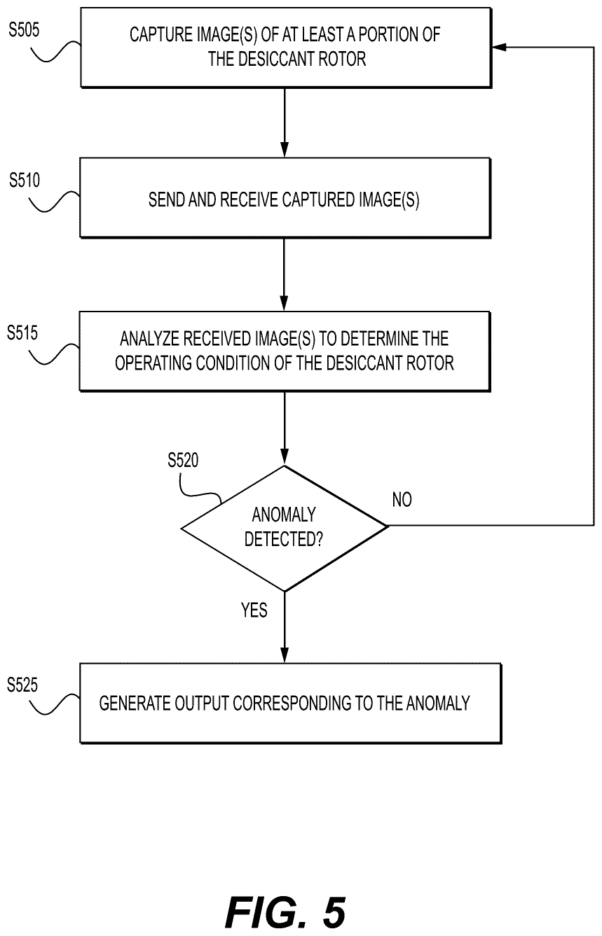

The rotor monitoring system 200 is used herein to determine an operating condition of the desiccant rotor 120, and FIG. 5 is a flow chart of the process (method) used by the rotor monitoring system 200 to determine an operating condition of the desiccant rotor 120. As discussed above, the image sensor 210 is positioned to capture an image of at least a portion of the desiccant rotor 120. The image sensor 210 captures, in step S505, at least one image of at least a portion of the desiccant rotor 120. The image sensor 210 may capture the image as part of the normal operation of the dehumidification system 100, and thus the image sensor 210 may continuously capture a plurality of images during the operation of the dehumidification system 100. The captured images may be stored, such as in memory 224, for subsequent image processing or undergo image processing relatively shortly after their capture. In other approaches, particularly when the image processor 230 is part of the separate computing device 232, as shown in FIG. 4, the image sensor 210 may capture images in response to a specific process, such as a diagnostic process.

The image sensor 210 is configured to send the images captured by the image sensor 210 to the image processor 230, and the image processor 230 is configured to receive the images from the image sensor 210. The captured images are sent and received in step S510. Then, in step S515, the image processor 230 is used to analyze the images captured by the image sensor 210 to determine an operating condition of the desiccant rotor 120. To make such a determination, the image processor 230 executes an image analysis process. Any suitable image analysis process may be used. For example, an artificial neural network trained, as discussed further below, to identify the operating conditions discussed herein may be used as the image analysis process, and thus the image analysis process executed by the image processor 230 includes executing a neural network model. A convolutional neural network may be particularly suitable for the applications discussed herein, and the neural network model may thus be a convolutional neural network model. When a convolutional neural network model is used, the image processor 230 may include a tensor processing unit (TPU).

The image to be analyzed includes the image captured by the image sensor 210. In some embodiments, as noted above, a plurality of image sensors 210, may be used. Images from each of those image sensors 210 may be analyzed individually in some embodiments, but in other embodiments the images captured from the plurality of image sensors 210 may be used to create a composite image to be analyzed. The captured image from multiple image sensors may be stitched together or layered by the image processor 230 using a suitable image stitching process or layering process to combine each captured image into one composite image to be analyzed.

Step S520 illustrates a decision point in the process. If the operating condition is a normal operating condition, either no action is taken or, when there are additional images to be analyzed, such as in a continuous process, the process returns to step S505, and the rotor monitoring system 200 continues to monitor the desiccant rotor 120 and/or analyze subsequent images. The analysis process, in step S515, is configured to detect at least one anomalous operating condition of the desiccant rotor 120, and when the image processor 230 identifies an anomalous operating condition, the process moves to step S525. Example anomalous operating conditions of the desiccant rotor 120 are discussed further below.

When the image processor 230 identifies an anomaly, the image processor 230 in step S525 may generate an output corresponding to the anomaly, referred to herein as anomaly information, and transmit the output (anomaly information) to a communicatively coupled device. In the embodiments shown in FIG. 3, the image processor 230 is coupled to the communicatively coupled device via the controller 220 and the actions discussed below are taken in conjunction with the controller 220.

The image processor 230 may be communicatively coupled to at least one indicator 240. When the image processor 230 identifies an anomaly, the image processor 230 may transmit the anomaly information to the indicator 240 to alert personnel of the anomaly. Any suitable indicator 240 may be used. For example, the indicator 240 may be a display screen 242, and, upon receipt of the anomaly information from the image processor 230, the display screen 242 displays information related to the anomaly, such as an alert. The alert may take any suitable form, including, for example, a symbol and/or text. When text is included in the alert, the type of anomaly may be indicated (e.g., perimeter seal leak) and the location of the anomaly (e.g., regeneration segment) may also be indicated. For example, the image processor 230 and/or controller 220 may determine from which image sensor 210 the anomaly is detected and use that information to determine the anomaly location. The image processor 230 and/or controller 220 then includes location information in the output to the display screen 242, and the display screen 242 uses the location information to display the location of the anomaly.

A light 244 is another suitable indicator 240. When the image processor 230 determines that an anomaly has occurred, the image processor 230 and/or controller 220 transmits an output to turn the light 244 on to provide an alert. Alternatively, the light 244 may be configured to flash in order to provide the alert. A speaker 246 is another suitable indicator 240. The image processor 230 and/or controller 220 may be configured to transmit an output that causes the speaker 246 to issue an audible alert.

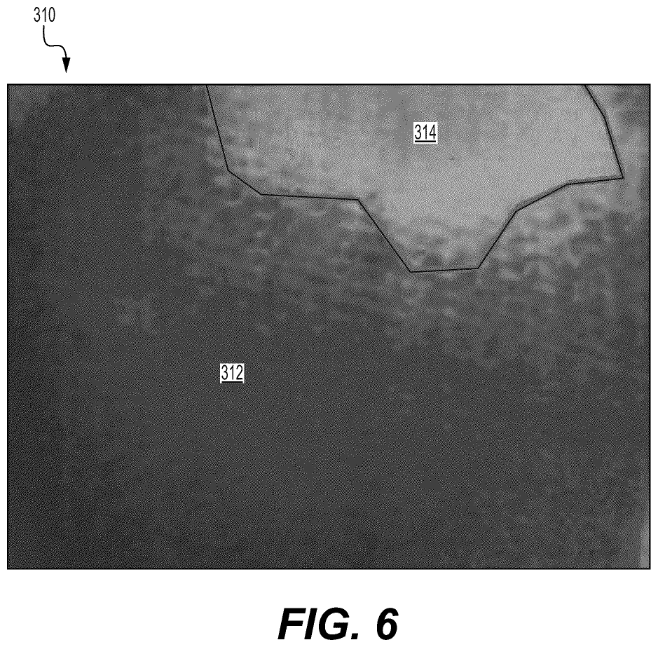

Such alerts or anomaly data may indicate that maintenance is necessary. For example, one anomalous condition is a localized temperature or moisture differential, indicating a leak in the seals of the seal assemblies 129. If a seal fails or is otherwise deteriorating, air and moisture content may leak into the field of view of the image sensor 210, resulting in a temperature or moisture content in a region of the image captured by the image sensor 210 that is different from surrounding regions. FIG. 6 is a grayscale representation of an image captured by the image sensor 210 that has a field of view of the first face 126 of the reactivation segment 124 (captured image 310). The reactivation segment 124 is used as an example, but the following discussion also applies to other portions and faces of the desiccant rotor 120. The majority of the captured image 310 (area 312) has an elevated temperature, but a localized region at the edge of the captured image 310 (area 314), as indicated by the lighter color in this image, has a reduced temperature relative to area 312. The image processor 230 thus may be configured to identify this anomaly and thus identify the leak in one of the seals of the seal assemblies 129. The region being monitored (area 312) has an operating temperature (e.g., an operating temperature of the reactivation segment 124), and the environment on the other side of the seal of the seal assembly 129 has another temperature, such as an ambient temperature in the case of the seal formed around the periphery of the desiccant rotor 120 or an operating temperature in the case the seal formed between of adjacent sectors (e.g., the process segment 122, the first isolation segment 162, or the second isolation segment 164). The temperature differential indicative of a leak may be, for example, based on the temperature differential between the two adjacent segments or regions, such as a percentage of the temperature differential between the two adjacent segments or regions. In the example shown in FIG. 6, the leak is occurring in the seal that is part of the seal assembly 129 formed around the periphery of the desiccant rotor 120. The image analysis process executed by the image processor 230 may also indicate the location of the anomalous condition (e.g., seal leak) based on where in the captured image 310 the area 314 is detected.

As noted above, the image analysis process executed by the image processor 230 to identify such anomalous conditions may be a machine learning process, such as an artificial neural network trained to identify the operating conditions indicative of a seal leak. A database of images may be used to train the artificial neural network (a training database). The training database may thus include a plurality of training images. When training the artificial neural network to identify seal leaks the training database may include images (training images) of the dehumidification system 100 operating with a cracked or otherwise failed seal of one of the seal assemblies 129. A plurality of such images may be used including training images having a failure located at different locations in the image and to different degrees of seal failure. When images of different degrees of seal failure are used in the training database, the artificial neural network may be trained to identify the severity of seal failure or other indicators that suggest a seal failure is likely to occur in the near future. Seal failure (leak) is one example of an anomalous condition indicative of a component failure or component deterioration. Other examples include wear of a rotating component of the desiccant rotor 120, such as the rollers 145, the shaft 147, and the bearings 149, and the training database may thus include training images of such conditions, in a manner similar to the training images for a seal leak.

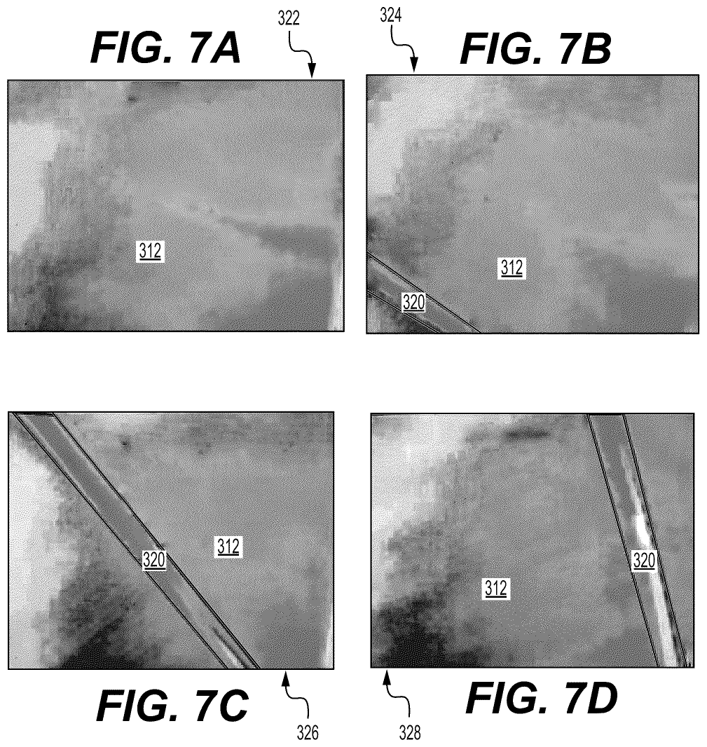

The artificial neural network may also be trained to avoid false positives, such as various structural components of the desiccant rotor 120 that periodically move through the field of view of the image sensor 210. For example, the desiccant rotor 120 may be formed of a plurality of segments of the fluted desiccant. Such segments may be separated by spokes that rotate through the field of view of the image sensor 210. FIGS. 7A-7D show a plurality of successive captured images 322, 324, 326, 328 similar to captured image 310 discussed above. The discussion of captured image 310 applies here and the same reference numerals (e.g., area 312) will be used in FIGS. 7A-7D to illustrate the same or similar features. In the first captured image 322, the spoke is not present, but in the second captured image 324 the spoke begins to rotate into the field of view of the image sensor 210. The image processor 230 thus identifies a long, localized area 320 of a relatively low temperature region as a spoke. In the third captured image 326, the spoke (area 320) has rotated further into the image, and in the fourth captured image 328 the spoke has again rotated still further into the field of view and the area 320. In training the artificial neural network, the training database may include images of the structural features of the desiccant rotor 120 at different or succussive positions within the field of view. As can be seen in the fourth captured image 328, the spoke may heat up (lighter region of area 320) as it rotates through the field of view, and thus having a plurality of successive images in the training database will help identify the spoke or other such features. The training database also may include a plurality of images showing a plurality of different structural features.

In the embodiment shown in FIG. 3, the controller 220 is operatively coupled to various systems of the dehumidification system 100. The image processor 230 may transmit the anomaly information to the controller 220, and when the controller 220 receives the anomaly information, the controller 220 may take an action based on the anomaly information. For example, the controller 220 may be operatively coupled to the process blower 118, the heater 137, the reactivation blower 138, the motor 141 for rotating the desiccant rotor 120, and the like. Such components are examples of adjustable components of the dehumidification system 100. The controller 220 is thus operatively coupled to at least one adjustable component to adjust the operation of the adjustable component, and the adjustable component may be, for example, one of a fan, a compressor, a pump, a valve, a damper, and an electric heater. Such components may be adjustable by the use of a drive mechanism, such as a motor, including a variable speed motor, and an actuator, and, more specifically, the controller 220 may be operatively coupled to the drive mechanism to operate or adjust the drive mechanism to adjust the operation of the adjustable component. Alternatively or additionally, such components may be adjustable by the use of a switch or relay.

With the rotor monitoring system 200 operatively coupled to the components discussed above, the rotor monitoring system 200 may thus be used to control the operation of the dehumidification system 100. For example, with the image sensor 210 positioned to monitor at least one of the first face 126 and the second face 128 of the reactivation segment 124, the anomaly condition identified in the image analysis process may be excess reactivation or insufficient reactivation. When the image processor 230 identifies that excess reactivation is occurring, the controller 220 may take an action to reduce the reactivation based on the anomaly information, such as by reducing the temperature of the reactivation air 14 (e.g., reducing the heat input of the heater 137), reducing the speed of the reactivation blower 138, increasing the rotational speed of the desiccant rotor 120 (motor 141), or a combination of these actions. Similarly, when the image processor 230 identifies that insufficient reactivation is occurring, the controller 220 may take an action to increase the reactivation based on the anomaly information, such as by increasing the temperature of the reactivation air 14 (e.g., increasing the heat input of the heater 137), increasing the speed of the reactivation blower 138, decreasing the rotational speed of the desiccant rotor 120 (motor 141), or a combination of these actions.

In another example, with the image sensor 210 positioned to monitor at least one of the first face 126 and the second face 128 of the process segment 122, the anomaly condition identified in the image analysis process may be excess dehumidification or insufficient dehumidification. When the image processor 230 identifies that excess dehumidification is occurring, the controller 220 may take an action to reduce the dehumidification based on the anomaly information, such as by increasing the speed of the process blower 118, increasing the rotational speed of the desiccant rotor 120 (motor 141), or a combination of these actions. Similarly, when the image processor 230 identifies that insufficient dehumidification is occurring, the controller 220 may take an action to increase the dehumidification based on the anomaly information, such as by decreasing the speed of the process blower 118, decreasing the rotational speed of the desiccant rotor 120 (motor 141), or a combination of these actions.

As discussed above, the training database may include various images of anomalous operating conditions as well as various images of normal operating conditions. The training database may include a plurality of images of anomalous operating conditions and a plurality of images of normal operating conditions. The plurality of images of anomalous operating conditions may include a plurality of images of anomalous conditions indicative of a component failure and a plurality of images of anomalous conditions indicative of component deterioration. The plurality of images of anomalous operating conditions may include images with these anomalous conditions located at different positions within the field of view of the image sensor 210. As noted above, the training database may include images of the structural features of the desiccant rotor 120 at different or successive positions within the field of view of the image sensor 210.

Both the anomalous operating conditions and the normal operating conditions may vary depending upon the environment in which the dehumidification system 100 is operated. For example, the anomalous operating conditions and the normal operating conditions will differ between warm and arid climates, hot and humid climates, and cold climates, and thus the training database preferably includes anomalous operating conditions and normal operating conditions from a plurality of climates.

The rotor monitoring system 200 has been described herein with reference to dehumidification systems 100, 102 and, more specifically, dehumidification systems 100, 102 using a rotating Honeycombe® wheel as the desiccant rotor 120. The rotor monitoring system 200 discussed herein is not limited to such systems and may be utilized in other dehumidification systems, such as dehumidification systems using a rotary bed (either a plurality of vertical beds or a horizontal bed). In addition, the rotor monitoring system 200 discussed herein may be utilized in other air conditioning systems, such as rotary sorbent systems used to scrub carbon dioxide (CO₂), for example.

Further aspects of the present invention are provided by the subject matter of the following clauses.

An air conditioning system for conditioning process air. The air conditioning system includes a rotor, an image sensor, and an image processor. The rotor contains a sorbent arranged in the rotor to allow the process air to flow therethrough. The image sensor is positioned to capture an image of at least a portion of the rotor. The image processor is configured to receive the image captured by the image sensor and to analyze, using an image analysis process executed by the image processor, the image to determine an operating condition of the rotor. The image analysis process is configured to detect at least one anomalous operating condition of the rotor, and when the image processor identifies the at least one anomalous operating condition, the image processor is configured to generate an output corresponding to the anomalous operating condition.

The air conditioning system the preceding clause, wherein the image analysis process executed by the image processor includes executing a neural network model.

The air conditioning system of the preceding clause, wherein the neural network model is a convolutional neural network model.

The air conditioning system of any preceding clause, wherein the neural network model has been trained using a training database comprising a plurality of images of at least a portion of the rotor.

The air conditioning system of any preceding clause, wherein the image is a thermal image showing relative temperatures of the portion of the rotor.

The air conditioning system of any preceding clause, wherein the image is a moisture content image showing relative moisture content of the portion of the rotor.

The air conditioning system of any preceding clause, further comprising an indicator communicatively coupled to the image processor to receive the output corresponding to the anomalous operating condition, the indicator providing an alert based on the output corresponding to the anomalous operating condition.

The air conditioning system of the preceding clause, wherein the indicator is a display screen and the alert includes at least one of a type of anomaly detected and a location of the anomalous operating condition detected.

The air conditioning system of any preceding clause, further including at least one adjustable component, and a controller operatively coupled to the at least one adjustable component and communicatively coupled to the image processor to receive the output corresponding to the anomalous operating condition. The controller is configured to adjust the at least one adjustable component of the air conditioning system based on the output corresponding to the anomalous operating condition.

The air conditioning system of any preceding clause, wherein the air conditioning system is a dehumidification system and the sorbent is a desiccant.

The air conditioning system of any preceding clause, wherein the rotor includes a plurality of segments including a first segment and a second segment, the image sensor being positioned such that the image of at least a portion of a rotor captured by the image sensor is a portion of the first segment.

The air conditioning system of any preceding clause, wherein the rotor includes a face, the image sensor being positioned such that the image of at least a portion of a rotor captured by the image sensor is a portion the face of the rotor in the first segment.

The air conditioning system of any preceding clause, wherein the rotor is configured to have air flow through the rotor in the first segment in an airflow direction.

The air conditioning system of any preceding clause, wherein air flowing through the rotor in the first segment is the process air.

The air conditioning system of any preceding clause, wherein air flowing through the rotor in the first segment is reactivation air.

The air conditioning system of any preceding clause, wherein the rotor includes a seal and the at least one anomalous operating condition of the rotor is a leak in the seal.

An image processing system for an air conditioning system. The image processing system includes an image processor. The image processor is configured to receive an image of at least a portion of a rotor in the air conditioning system. The rotor includes sorbent arranged in the rotor to allow air to flow therethrough. The image processor is also configured to analyze, using an image analysis process executed by the image processor, the image to determine an operating condition of the rotor. The image analysis process is configured to detect at least one anomalous operating condition of the rotor, and when the image processor identifies the at least one anomalous operating condition, the image processor is configured to generate an output corresponding to the anomalous operating condition.

The image processing system of the preceding clause, wherein the image analysis process executed by the image processor includes executing a neural network model.

The image processing system of the preceding clause, wherein the neural network model is a convolutional neural network model.

The image processing system of the preceding clause, wherein neural network model has been trained using a training database comprising a plurality of images of at least a portion of the rotor.

The image processing system of any preceding clause, wherein the image is a thermal image showing relative temperatures of the portion of the rotor.

The image processing system of any preceding clause, wherein the image is a moisture content image showing relative moisture content of the portion of the rotor.

The image processing system of any preceding clause, further comprising a display screen communicatively coupled to the image processor to receive the output corresponding to the anomalous operating condition, the display screen displaying an alert based on the output corresponding to the anomalous operating condition.

The image processing system of any preceding clause, wherein the alert includes at least one of a type of anomaly detected and a location of the anomalous operating condition detected.

A method of detecting anomalies in a rotary sorbent air conditioning system. The method includes receiving an image of at least a portion of a rotor containing a sorbent. The sorbent is arranged in the rotor to allow air to flow therethrough. The method also includes analyzing, using an image analysis process executed by an image processor, the image to determine an operating condition of the rotor. The image analysis process is configured to detect at least one anomalous operating condition of the rotor, and when the image processor identifies the at least one anomalous operating condition, the method includes generating an output corresponding to the anomalous operating condition.

The method of the preceding clause, further comprising capturing the image of at least a portion of the rotor containing a sorbent, using an image sensor.

The method of any preceding clause, wherein the image analysis process executed by the image processor includes executing a neural network model.

The method of any preceding clause, wherein the neural network model is a convolutional neural network model.

The method of any preceding clause, wherein neural network model has been trained using a training database comprising a plurality of images of at least a portion of the rotor.

The method of any preceding clause, wherein the image is a thermal image showing relative temperatures of the portion of the rotor.

The method of any preceding clause, wherein the image is a moisture content image showing relative moisture content of the portion of the rotor.

The method of any preceding clause, further comprising generating an alert based on the output corresponding to the anomalous operating condition.

The method of any preceding clause, wherein the alert includes at least one of a type of anomaly detected and a location of the anomalous operating condition detected.

The method of any preceding clause, further comprising adjusting, using a controller communicatively coupled to the image processor to receive the output corresponding to the anomalous operating condition, at least one adjustable component of the air conditioning system based on the output corresponding to the anomalous operating condition.

A non-transitory computer-readable storage medium having stored thereon a sequence of instructions that, when executed by a processor, causes the processor to perform an image analysis process to determine an operating condition of a rotor of a rotary sorbent air conditioning system. The image analysis process executed by the processor includes executing a neural network model that has been trained using a training database comprising a plurality of training images of at least a portion of a face of the rotor. The rotor contains a sorbent.

The non-transitory computer-readable storage medium of the preceding clause or the training database of any preceding clause, wherein the training images include a plurality of images of a face of the rotor with a structural feature of the rotor.

The non-transitory computer-readable storage medium of any preceding clause or the training database of any preceding clause, wherein the plurality of images of the face of the rotor with a structural feature of the rotor shows a plurality of different structural features.

The non-transitory computer-readable storage medium of any preceding clause or the training database of any preceding clause, wherein the plurality of images of the face of the rotor with a structural feature of the rotor shows a first structural feature at a plurality of different positions.

The non-transitory computer-readable storage medium of any preceding clause or the training database of any preceding clause, wherein the plurality of different positions are successive positions.

The non-transitory computer-readable storage medium of any preceding clause or the training database of any preceding clause, wherein the training images include a plurality of images of a face of the rotor with a seal failure.

The non-transitory computer-readable storage medium of any preceding clause or the training database of any preceding clause, wherein the plurality of images of the face of the rotor with a seal failure shows the seal failure at a plurality of different positions.

The non-transitory computer-readable storage medium of any preceding clause or the training database of any preceding clause, wherein the plurality of images of the face of the rotor with a seal failure shows the seal failure at a plurality of different degrees of seal failure.

The non-transitory computer-readable storage medium of any preceding clause or the training database of any preceding clause, wherein the training images include a plurality of images of a face of the rotor with wear of a rotating component of the rotor.

The non-transitory computer-readable storage medium of any preceding clause or the training database of any preceding clause, wherein the rotating component is one of a roller, a shaft, and a bearing.

The non-transitory computer-readable storage medium of any preceding clause or the training database of any preceding clause, wherein the plurality of images of the face of the rotor with wear of the rotating component shows the wear at a plurality of different degrees.

The non-transitory computer-readable storage medium of any preceding clause or the training database of any preceding clause, wherein the training images include a plurality of images of a face of the rotor with normal operating conditions.

The non-transitory computer-readable storage medium of any preceding clause or the training database of any preceding clause, wherein the plurality of images of a face of the rotor with anomalous operating conditions shows the normal operating conditions from a plurality of climates.

The non-transitory computer-readable storage medium of any preceding clause or the training database of any preceding clause, wherein the training images include a plurality of images of a face of the rotor with anomalous operating conditions.

The non-transitory computer-readable storage medium of any preceding clause or the training database of any preceding clause, wherein the plurality of images of a face of the rotor with anomalous operating conditions includes a plurality of images of anomalous conditions indicative of a component failure.

The non-transitory computer-readable storage medium of any preceding clause or the training database of any preceding clause, wherein the plurality of images of a face of the rotor with anomalous operating conditions includes a plurality of images of anomalous conditions indicative of a component deterioration.

The non-transitory computer-readable storage medium of any preceding clause or the training database of any preceding clause, wherein the plurality of images of a face of the rotor with anomalous operating conditions shows the anomalous operating conditions at a plurality of different positions.

The non-transitory computer-readable storage medium of any preceding clause or the training database of any preceding clause, wherein the plurality of images of a face of the rotor with anomalous operating conditions shows the anomalous operating conditions from a plurality of climates.

Although this invention has been described with respect to certain specific exemplary embodiments, many additional modifications and variations will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. An air conditioning system for conditioning process air, the air conditioning system comprising:
a rotor containing a sorbent, the sorbent being arranged in the rotor to allow the process air to flow therethrough;
an image sensor positioned to capture an image of at least a portion of the rotor; and
an image processor configured to:
receive the image captured by the image sensor;
analyze, using an image analysis process executed by the image processor, the image to determine an operating condition of the rotor, the image analysis process being configured to detect at least one anomalous operating condition of the rotor; and
generate, when the image processor identifies the at least one anomalous operating condition, an output corresponding to the anomalous operating condition.

2. The air conditioning system of claim 1, wherein the image analysis process executed by the image processor includes executing a neural network model.

3. The air conditioning system of claim 2, wherein the neural network model is a convolutional neural network model.

4. The air conditioning system of claim 2, wherein the neural network model has been trained using a training database comprising a plurality of images of at least a portion of the rotor.

5. The air conditioning system of claim 1, wherein the image is a thermal image showing relative temperatures of the portion of the rotor.

6. The air conditioning system of claim 1, wherein the image is a moisture content image showing relative moisture content of the portion of the rotor.

7. The air conditioning system of claim 1, further comprising an indicator communicatively coupled to the image processor to receive the output corresponding to the anomalous operating condition, the indicator providing an alert based on the output corresponding to the anomalous operating condition.

8. The air conditioning system of claim 7, wherein the indicator is a display screen and the alert includes at least one of a type of anomaly detected and a location of the anomalous operating condition detected.

9. The air conditioning system of claim 1, further comprising:
at least one adjustable component; and
a controller operatively coupled to the at least one adjustable component and communicatively coupled to the image processor to receive the output corresponding to the anomalous operating condition, the controller being configured to adjust the at least one adjustable component of the air conditioning system based on the output corresponding to the anomalous operating condition.

10. The air conditioning system of claim 1, wherein the air conditioning system is a dehumidification system and the sorbent is a desiccant.

11. The air conditioning system of claim 1, wherein the rotor includes a plurality of segments including a first segment and a second segment, the image sensor being positioned such that the image of at least a portion of a rotor captured by the image sensor is a portion of the first segment.

12. The air conditioning system of claim 11, wherein the rotor includes a face, the image sensor being positioned such that the image of at least a portion of a rotor captured by the image sensor is a portion of the face of the rotor in the first segment.

13. The air conditioning system of claim 12, wherein the rotor is configured to have air flow through the rotor in the first segment in an airflow direction, the air flowing through the rotor in the first segment is the process air.

14. The air conditioning system of claim 12, wherein the rotor is configured to have air flow through the rotor in the first segment in an airflow direction, the air flowing through the rotor in the first segment is reactivation air.

15. The air conditioning system of claim 1, wherein the rotor includes a seal and the at least one anomalous operating condition of the rotor is a leak in the seal.

16. An image processing system for an air conditioning system, the image processing system comprising:
an image processor configured to:
receive an image of at least a portion of a rotor in the air conditioning system, the rotor including sorbent arranged in the rotor to allow air to flow therethrough;
analyze, using an image analysis process executed by the image processor, the image to determine an operating condition of the rotor, the image analysis process being configured to detect at least one anomalous operating condition of the rotor; and
generate, when the image processor identifies the at least one anomalous operating condition, an output corresponding to the anomalous operating condition.

17. The image processing system of claim 16, wherein the image analysis process executed by the image processor includes executing a neural network model.

18. A method of detecting anomalies in a rotary sorbent air conditioning system, the method comprising:
receiving an image of at least a portion of a rotor containing a sorbent, the sorbent being arranged in the rotor to allow air to flow therethrough;
analyzing, using an image analysis process executed by an image processor, the image to determine an operating condition of the rotor, the image analysis process being configured to detect at least one anomalous operating condition of the rotor; and
generating, when the image processor identifies the at least one anomalous operating condition, an output corresponding to the anomalous operating condition.

19. The method of claim 18, further comprising capturing the image of at least a portion of the rotor containing a sorbent, using an image sensor.

20. The method of claim 18, wherein the image analysis process executed by the image processor includes executing a neural network model.
